(19) United States
(12) Patent Application Publication
(10) Pub. No.: US 2010/0261061 A1
(43) Pub. Date: Oct. 14, 2010

(54) Positive electrode material for lithium secondary battery, positive electrode plate for lithium secondary battery, and lithium secondary battery using the same

(76) Inventors: Toyotaka Yuasa, Hitachi (JP); Sai Ogawa, Tokai (JP); Hirofumi Takahashi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/502,434

(22) Filed: Aug. 11, 2006

(30) Foreign Application Priority Data
Aug. 12, 2005 (JP) 2005-234159

(51) Int. Cl. H01M 4/583; H01M 4/90

(52) U.S. Cl. 429/231.8; 252/182.1

(57) ABSTRACT

A positive electrode material for a lithium secondary battery according to the invention includes a positive electrode active material containing lithium oxide and a carbon composite obtained by dispersing carbon fiber and a clamped shape carbon material, and the positive electrode active material is combined with the carbon composite. In the positive electrode material for a lithium secondary battery constructed as described above, a conductive network between primary particles is formed by the carbon composite while the positive electrode active material (primary particles) are condensed to form secondary particles.

### BACKGROUND OF THE INVENTION

1. Field of the Invention

The present invention relates to a novel positive electrode material for a lithium secondary battery, a novel positive electrode plate for a lithium secondary battery, and a lithium secondary battery using the same, and more particularly, to a positive electrode material used in a large-size lithium secondary battery containing nonaqueous electrolyte and a lithium secondary battery using the same.

2. Background Art

As a power supply for a hybrid vehicle capable of efficiently using energy, a battery having high output power and high energy density is demanded in the art. Since a lithium secondary battery has a high voltage level and a light weight and stores high energy density, it is prospectively used as, for example, a hybrid vehicle battery. In the hybrid vehicle secondary battery, the energy is regenerated and stored when the vehicle is decelerated, and then, high-rate discharge is necessarily performed for ten seconds in order to assist acceleration. This battery should have an excellent input/output characteristic for ten seconds and a long life span, and safely operate within a wide temperature range. In order to improve the input/output characteristic, it has been reviewed that the electrode resistance is reduced by, for example, improving conductivity of electrons in the electrode. On the other hand, in order to expand the operational temperature range, functionality electrolyte in which reduction of a lithium ion transporting characteristic is inhibited at low temperature has been developed, or a structure of the electrode has been optimized. In addition, in order to guarantee a long life span, a positive electrode active material, having a layer structure of which a crystal structure is safe even after the battery is stored for a long time or after a charge/discharge cycle is repeated many times, has been developed.

In order to improve the input/output characteristic, the electrode resistance should be reduced. The electrode resistance is typically generated by the following reasons: firstly, an electron conductivity component is a resistance component generated in a time interval within 100 ms after discharge is initiated, and is also a contact resistance component in a charge collector, a conductive material, and a positive electrode active material; secondly, an in-particle diffusion component is a resistance component generated in a time interval within 50 to 500 ms after discharge is initiated, and is generated when lithium ions are diffused in the positive electrode active material; and finally, an in-electrolyte mobility component is a resistance component generated within 500 ms after discharge is initiated, and is also a resistance component generated until lithium ions arrive in the surface of the positive electrode active material after passing through interstitial of the positive electrode active material from the surface of the electrode.

In order to reduce the amount of electron conductivity components and the amount of in-electrolyte mobility components, the positive electrode construction including a conductive material and a positive activation material has been considered as follows.

For example, in Japanese Patent Application Laid-Open No. 11-345607, reduction of the electrode resistance has been tried in such a way that a conductive path is formed in the electrode by adding clumped carbon such as spheroidal graphite and fiber shape carbon such as vapor growth carbon fiber (VGCF) to a positive electrode material to improve electron conductivity. In this document, the electric resistance on the surface of the positive electrode active material is reduced by covering it with the spheroidal graphite, and the conductive path between the positive electrode active materials is formed by the fiber shape carbon, so that reduction of resistivity of the positive electrode has been tried. Reduction of an initial voltage for one second after discharge is initiated can be prevented by improving the electron conductivity. However, in this method, since the surface of the positive electrode active material is coated with the spheroidal graphite, the diffusion of lithium ions into the surface of the positive electrode active material is inhibited. For this reason, the electrode resistance required in a hybrid vehicle battery within ten seconds cannot be reduced.

On the other hand, in Japanese Patent Application No. 2002-358966, the electrolyte is retained with the clumped amorphous carbon by mixing clumped amorphous carbon into the electrode, so that the lithium ions are supplied to the surface of the positive electrode active material in order to try to inhibit resistance increase caused by high-rate discharge. However, in this electrode construction, it is difficult to form a conductive path between the positive electrode active materials.

As described above, in the high output power lithium secondary battery, the electrode resistance should be reduced for ten seconds after the discharge is initiated. However, any patent document fails to disclose simultaneous pursuit of a formation of a conductive path between particles of the positive electrode active material and a liquid-retaining property of electrolyte.

### SUMMARY OF THE INVENTION

As described above, according to the Background art, the positive electrode material for a lithium secondary battery has high electric resistance and cannot realize preferred output power characteristics. Accordingly, the present invention is made to provide a positive electrode material for a lithium secondary battery having low electrode resistance, a positive electrode for a lithium secondary battery, and a lithium secondary battery using the same.

According to the present invention achieving the above object, a positive electrode material for a lithium secondary battery is provided by combining a positive electrode active material containing lithium oxide with a carbon composite made by dispersing carbon fiber and a clumped carbon material. In the positive electrode material for a lithium secondary battery formed as described above, while the positive electrode active materials (primary particles) are condensed to form secondary particles, a conductive network between primary particles is formed by the carbon composite.

According to the present invention, the carbon fiber is preferably hollow fiber, and a side wall preferably has an opening. In this case, the diameter of the opening is preferably 10 to 50 nm. In this construction of the positive electrode material for a lithium secondary battery, electrolyte is provided in an inner space of the carbon fiber. Since the carbon fiber has the aforementioned conductive network, electrolyte can be moved in a high velocity through the carbon fiber. In this case, the catalyst for covering an end portion of the carbon fiber is preferably removed. As described above, the electrolyte can be easily penetrated into the carbon fiber by removing the catalyst in the end portion of the carbon fiber and providing an opening on the side wall. Particularly, if the diameter of the carbon fiber is 10 nm or less, the solvated lithium ions are difficult to be penetrated into the inner space of the hollow carbon fiber. Therefore, the diameter of the carbon fiber is preferably 10 nm or more.

On the other hand, the clumped carbon fiber has an excellent liquid-retaining property for the electrolyte. The electrode resistance can be further reduced as follows by combining this clumped carbon material with carbon fiber. That is, when the lithium ions are short on the surface of the positive electrode active material due to high-rate discharge, the electrolyte can be supplied from the clumped carbon material to the carbon fiber forming the conductive network, so that the lithium ions can be rapidly supplemented to the surface of the positive electrode active material through this conductive network. As a result, it is possible to reduce the electrode resistance.

In addition, in the positive electrode active material for a lithium secondary battery according to the present invention, the length of the carbon of the carbon fiber is preferably set to 1 to 8 μm in average, and the average particle diameter of the clumped carbon material is preferably set to 100 nm or less. Furthermore, the liquid absorption amount of the carbon composite is preferably set to 5 cc/g or more. In addition, the carbon fiber in the carbon composite has a weight percentage of 50 to 90 wt. %.

In addition, the positive electrode active material may be layered composite oxide having a chemical formulation of LiₐMO₂, where 0<a≦1.2, and M is at least one material selected from a group consisting of Co, Ni, and Mn. The layered composite oxide may have a chemical formulation of LiₐMnₓNi_{y}Co_{z}O₂ (0<a≦1.2, 0.1≦x≦0.9, 0.1≦y≦0.44, 0.1≦z≦0.6, and x+y+z=1).

According to the present invention, it is possible to provide a positive electrode material for a lithium secondary battery having low resistance, a positive electrode plate for a lithium secondary battery using this positive electrode material, and a lithium secondary battery using the same. According to the positive electrode material for a lithium secondary battery according to the present invention, it is possible to achieve excellent electron conductivity in the electrode, and thus, it is possible to construct a lithium secondary battery having an excellent input/output power characteristic.

### BRIEF DESCRIPTION OF THE DRAWINGS

FIG. 1 is a schematic diagram illustrating a surface of a positive electrode material for a lithium secondary battery according to the present invention.

FIG. 2 is a partially cutaway front elevation illustrating a construction of a lithium secondary battery according to the present invention.

FIG. 3 is a graph for showing a relationship between the length of hollow carbon fiber and internal resistance of a battery.

FIG. 4 is a graph for showing a relationship between a diameter of hollow carbon fiber and internal resistance of a battery.

FIG. 5 is a schematic diagram illustrating a surface of a positive electrode material for a lithium secondary battery.

### DESCRIPTION OF THE PREFERRED EMBODIMENTS

Hereinafter, a positive electrode material for a lithium secondary battery, a positive electrode plate for a lithium secondary battery, and a lithium secondary battery according to the present invention will be described in detail with reference to the accompanying drawings.

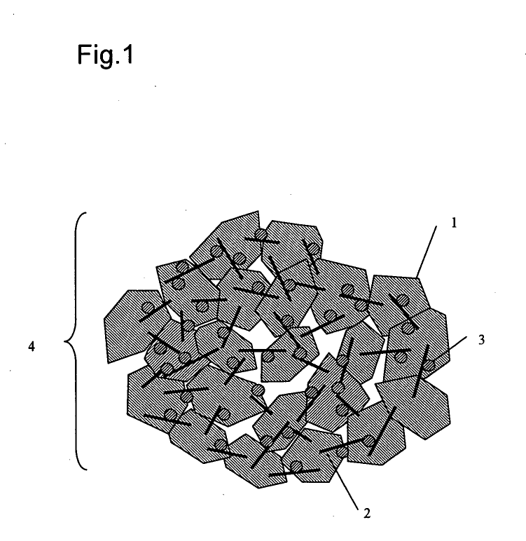

Referring to FIG. 1, a positive electrode material for a lithium secondary battery according to the present invention is obtained by combining a positive electrode active material 1 containing lithium oxide with a carbon composite obtained by dispersing carbon fiber 2 and a clumped carbon material 3. In the positive electrode material for a lithium secondary battery, the carbon fiber 2 electrically interconnects neighboring primary particles with one another in the secondary particles 4 formed by condensing the primary particles of the positive electrode active material 1. In addition, the clumped carbon material 3 makes contact with the carbon fiber 2.

In the positive electrode material for a lithium secondary battery constructed as described above, a conductive network is formed between the primary particles of the positive electrode active material 1 by the carbon composite containing the carbon fiber 2 and the clumped carbon material 3.

Any material having a shape for allowing the conductive network to be formed may be used as the carbon fiber 2. For example, a carbon nanotube or vapor deposited carbon fiber having a high aspect ratio and a fiber length of 1 to 8 μm in average may be used. In this case, the carbon fiber 2 preferably has a fiber length three or four times an average primary particle diameter because the conductive network should be formed by interconnecting the primary particles of the positive electrode active material with one another. In addition, the diameter of the carbon fiber 2 is preferably 100 nm or less because the conductive network can be easily formed if the carbon fiber has a high aspect ratio.

The carbon fiber 2 is preferably hollow fiber, i.e., hollow carbon fiber. When a lithium secondary battery containing electrolyte is formed using a positive electrode material for a lithium secondary battery, the electrolyte can move in an inner space of the hollow carbon fiber in a high velocity, so that the inherited resistance of materials in the electrolyte can be reduced, and thus, high-rate discharge can be implemented.

The carbon fiber 2 is preferably hollow carbon fiber having an opening on its side wall. The diameter of the opening is preferably 10 to 50 nm. The opening on the side wall may be formed by mixing hollow carbon fiber having no opening with a shearing force being applied. In the hollow carbon fiber having an opening on its side wall, the electrolyte can be easily penetrated into the inner space. In addition, the catalyst existing in the end portion of the hollow carbon fiber may be removed during a process of forming the opening on the side wall. The electrolyte can be easily penetrated into the inner space by removing the catalyst from the end portion of the hollow carbon fiber. As described above, the electrolyte can move more rapidly through the inner space of the hollow carbon fiber by using the hollow carbon fiber in which the opening is provided in the side wall and the catalyst is removed from the end portion, so that the inherited resistance of materials in the electrolyte can be further reduced, and high-rate discharge can be implemented. Particularly, when the diameter of the carbon fiber is 10 nm or less, the solvated lithium ions are difficult to be penetrated into the inner space of the hollow carbon fiber. Therefore, the carbon fiber preferably has a diameter of 10 nm or more.

The clumped carbon material 3 may include any carbon material having a liquid-retaining property for the electrolyte. The electrolyte can be retained in the clumped carbon material because pores or voids are provided in the inside of the particles. A graphited carbon material or an amorphous carbon material may be used as the clumped carbon material. According to the present invention, either of the graphited carbon material and the amorphous carbon material may be used as the clumped carbon material, or a mixture of them may be used.

A carbon material has a hexagonal mesh face stack body as a basic structure. Graphite is obtained by stacking the hexagonal mesh faces with a three-dimensional regularity. Carbon is classified into easily-graphitable carbon and hardly-graphitable carbon depending on the regularity of this graphite structure, i.e., the hexagonal mesh face layers. Easily-graphitable carbon includes cokes, and hardly-graphitable carbon includes carbon black such as acetylene black. The graphite may be obtained by performing a thermal processing for an easily-graphitable carbon material obtained from petroleum cokes, coal pitch cokes, or the like at a temperature of 2500° C. or more. On the other hand, cokes may be obtained by performing a thermal processing for the coal or oil residuals or coal tar pitch. Carbon black may be obtained by performing a thermal decomposition for natural gas or acetylene gas. In this case, hardly-graphitable carbon is characterized in that voids or pores are provided in the inside of the carbon particles. Typically, conventional hardly-graphitable carbon such as acetylene black is constructed of very minute particles having an average particle diameter of 10 to 50 nm and a large specific surface area, for example, a BET specific surface of 5 to 50 m²/g.

On the other hand, clumped amorphous carbon has the same particle diameter as that of a graphited carbon material as well as the same property as that of hardly-graphitable carbon, and also has voids or pores in the inside of the particle. In comparison with conventional hardly-graphitable carbon having a minute particle shape, since an amorphous conductive material has a relatively large particle shape and a particle diameter similar to that of graphite, it is called a clumped carbon material. According to the present invention, in order not to inhibit movement of lithium ions due to the coat on the surface of the positive electrode active material, the clumped carbon material 3 preferably has a diameter of 100 nm or less.

The amount of retained electrolyte of a carbon composite containing carbon fiber 2 and a clumped carbon material 3 is preferably 3 cc/g or more, more preferably, 5 cc/g or more. When the amount of the retained electrolyte in a carbon composite is set to 3 cc/g or more, it is possible to guarantee high-rate discharge. In this case, the amount of retained electrolyte is measured using electrolyte containing carbonate solvent and LiPF₆. Specifically, the amount of added electrolyte per 1 g of a carbon composite is measured as the amount of retained electrolyte when the electrolyte and the carbon composite are regularly mixed to form a clumped shape according to a JIS-K5101 oil absorption measurement.

When the amount of retained electrolyte of the carbon composite is too large, it may be difficult to manufacture an electrode having low resistance for the following reasons. During the electrode manufacturing process, the carbon composite and the positive electrode active material 1 are blended, and a binder is added to provide slurry. Then, the slurry is coated to provide an electrode. At these processes, since the binder is absorbed in the carbon composite having a large amount of retained electrolyte, adherence between a charge collector and the positive electrode active material 1 is decreased, so that the electrode resistance may increase. For this reason, the amount of retained electrolyte of the carbon composite is preferably set to 25 cc/g or less.

As described above, the carbon fiber 2 is necessary in order to provide a conductive network that contributes to reduction of material movement resistance in the electrolyte and improvement of electron conductivity. Also, the clumped carbon material 3 is necessary in order to increase the amount of retained electrolyte in the electrode. The composition of a carbon material becomes important in order to reduce the electrode resistance because these carbon materials are combined to provide an electrode. In this case, the composition of carbon fiber 2 in the carbon composite preferably has a weight percentage of 50 wt. % or more in order to provide a conductive network. The weight percentage of the clumped carbon material 3 in a carbon composite is preferably 10 wt. % or more in order to sufficiently achieve the effect of reduction of the electrode resistance which is caused by improvement of the electrolyte-retaining property by adding the clumped carbon material 3. Accordingly, the weight percentage of the carbon fiber contained in the carbon composite is preferably set to 50 to 90 wt. %.

Subsequently, a method of dispersing the carbon fiber 2 and the clumped carbon material 3 with the positive electrode active material 1 will be described below. Typically, when two pieces of carbon fiber 2 having a diameter of 500 nm or less and a high aspect ratio are adjacent to each other, an attracting force across the entire length between the pieces of carbon fiber becomes large due to the van der Waals interaction. Therefore, the carbon fiber 2 may easily produce irregularly cohered bundles. In order to disperse the carbon fiber 2, these bundles should be unbound. Firstly, powder of the carbon fiber 2 is injected into a ball mill, and mixed with a shearing force being applied. If the mixing is continued for a long item in this dispersing process, the bundles of the carbon fiber 2 are unbound and shorn. At the same time, the catalyst in the end portion of the carbon fiber 2 is removed, and a defect is introduced into the side face of the carbon fiber 2 to provide the opening.

Subsequently, the clumped carbon material 3 is injected into the ball mill and mixed with the carbon fiber 2, and the clumped carbon material 3 is highly dispersed in the vicinity of the carbon fiber 2, so that a formation of a carbon composite is achieved. Finally, in order to combine the positive electrode active material 1 with this carbon composite, the positive electrode active material 1 is injected into the ball mill and the mixing is performed. As a result of this process, the carbon composite is dispersed into the particle surface of the positive electrode active material 1 of which the surface is activated by a mechanical working of the ball mill, and a minute coat layer is locally formed on the particles of the positive electrode active material 1, so that it is possible to obtain a combined positive electrode material for a lithium secondary battery. In addition, considering that the particles of the positive electrode active material 1 may be broken down by performing the dispersion process for an excessively long time, and the electron conductivity of the positive electrode active material 1 may be decreased, it is preferable that the processing time is appropriately adjusted.

According to the present invention, the positive electrode active material 1 is not particularly limited, but lithium oxide or a composition containing lithium oxide may be used as known in the art. More preferably, a positive electrode active material 1 having the following particle structure may be preferably used in order to reduce electrode resistance as the positive electrode.

The particle structure of the positive electrode active material 1 is preferably constructed of secondary particles obtained by condensing primary particles having an average particle diameter of 0.1 to 3 μm and a specific surface area of 1 m²/g or more. The pores between the primary particles preferably have a diameter of 0.1 to 1 μm or less in average in order to interconnect the primary particles with one another using carbon fiber. In addition, from the viewpoint of the electrolyte retention in the vicinity of the primary particles of the positive electrode active material 1, the accumulated amount of mercury penetrated into the pores is preferably 0.1 to 0.3 ml/g when the pore distribution is measured using a mercury penetration method. The secondary particle 4 of the positive electrode active material 1 preferably has a spherical shape similar to that of the medium of the ball mill in order to disperse the carbon fiber with the ball mill.

If the positive electrode active material 1 has an average primary particle diameter not larger than 0.1 μm, it is difficult to handle it in a manufacturing technique, so that product cost may increase. Since the crystal volume of the positive electrode active material 1 is repeatedly expanded and contracted according to charge/discharge operations, the diameter of the pore between the primary particles is preferably 0.1 μm or more. In addition, since the diameter of the pore between the primary particles is small, the positive electrode material 1 preferably has little expansion/contraction of the crystal volume according to charge/discharge operations. In consideration with cost of a lithium secondary battery, the positive electrode active material 1 preferably has a small amount of cobalt. In order to achieve a balance between reduction of expansion/contraction of the crystal volume and low cost, the positive electrode active material 1 is preferably formed of layered composite oxide having a chemical formulation of LiₐMnₓNi_{y}Co_{z}O₂ (0<a≦1.2, 0.1≦x≦0.9, 0.1≦y≦0.44, 0.1≦z≦0.6, and x+y+z=1). In addition, the positive electrode active material 1 may be oxide having a spinel type crystal structure such as LiMn₂O₄. Manganese oxide such as LiMn₂O₄ or Li₁₊ₓMn₂₋ₓO₄ may be used in order to output high power. In this case, X is preferably set to 0.01 to 0.33.

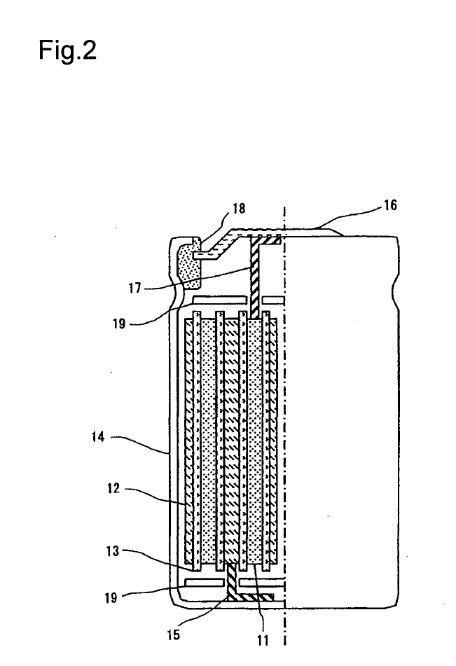

A lithium secondary battery can be manufactured using the aforementioned positive electrode material for a lithium secondary battery. As shown in FIG. 2, the lithium secondary battery may comprise: a positive electrode plate 10 made by coating the aforementioned positive electrode material onto both sides of, for example, an aluminum foil; a negative electrode plate 11; a separator 12 interposed between the positive and negative electrode plates 10 and 11; a positive electrode lead 13 connected to the positive electrode plate 10; a negative electrode lead 14 connected to the negative electrode plate 11; a battery can 15 of which the bottom face is connected to the negative electrode lead 14; and a seal cover 17 corking the end of the path of the battery can 15 with an insulating material 16 and connected to the positive electrode lead 13. The positive electrode plate 10, the separator 12, and the negative electrode plate 13 are stacked in this order and wound, and then installed in an inner space of the battery can 15 as an electrode assembly. The electrode assembly is installed in the space interposed between the packings 18. The electrolyte (not shown) is filled in the space surrounded by the battery can 15 and the seal cover 17.

In a lithium secondary battery manufactured using a positive electrode material according to the present invention, it is possible to reduce a contact resistance component in the positive electrode plate 10 due to the conductive network constructed of carbon fiber, and diffuse lithium ions into the inside of the positive electrode active material, so that the in-electrolyte mobility component can be reduced. In other words, in a lithium secondary battery, it is possible to reduce all of resistance components including: a contact resistance component of the charge collector, the conductive material, and the positive electrode active material, generated for 100 ms after discharge is initiated; an in-particle diffusion component generated for 50 to 500 ms after discharge is initiated when the lithium ions are diffused into the inside of the positive electrode active material; and an in-electrode mobility component generated in 500 ms later after discharge is initiated until the lithium ions start to move from the surface of the electrode, pass through the interstitial of the positive electrode active materials, and arrive at the surface of the positive electrode active material. As a result, according to the lithium secondary battery according to the present invention, it is possible to reduce 10-second electrode resistance necessary for a hybrid vehicle battery.

The lithium secondary battery according to the present invention may be used in any fields including, without limitation to, an intermediate or high capacity power supply in various industrial devices. For example, the lithium secondary battery according to the present invention may be suitably used in an electric vehicle, a lightweight vehicle, a hybrid vehicle which uses both of a power source driven by various engines and a power supply generated from a motor, or a railway motor car. In addition, the lithium secondary battery according to the present invention may be used in intermediate capacity electric appliances widely used in a common life.

### EXAMPLES

The present invention will be more apparent by reading the following Examples which will be described in detail with reference to the accompanying drawings, and the scope of the invention is not limited by these Examples.

### Example 1

Firstly, a method of manufacturing a positive electrode active material will be described. Manganese dioxide, cobalt oxide, nickel oxide, and lithium carbonate are used as source materials. The materials were weighed such that the atomic ratio of Ni:Mn:Co is set to 1:1:1, and the atomic ratio of Li:(NiMnCo) is set to 1.06:1, and then, pure water was added. Using a pot made of resin and a ball mill with a zirconia ball, the materials are pulverized and mixed in a wet environment for five to an hundred hours so that the particle diameter was reduced to a submicron scale. A polyvinyl alcohol (PVA) liquid was added to a mixture with a solid content ratio of 2 wt. %, mixed again for an hour, and granulated and dried using a spray drier, so that particles having a diameter of 5 to 20 μm in average were produced. Subsequently, these particles were baked at a temperature of 1000° C. for three to ten hours so as to form a layered crystal structure, and then decomposed to provide a positive electrode active material. Bulky particles having a diameter of 30 μm or more were removed from the positive electrode active material through a classification process, and then the resulting material was applied in an electrode manufacturing.

Subsequently, natural properties of hollow carbon fiber and a hollow clumped carbon material added to the positive electrode active material and a method of mixing them will be described. Hollow carbon fiber having an average diameter of 10 to 150 nm and an average length of 1 to 10 μm and a hollow clumped carbon material having an average diameter of 100 nm were mixed using a planetary ball mill for six hours to obtain a carbon composite. In this case, a weight percentage of the hollow clumped carbon material included in the mixed carbon material was set to 25 wt. %.

Then, the obtained carbon composite was mixed with the positive electrode active material powder (a) to (c) with a weight percentage of 6.1 wt. % using a centrifugal ball mill for one to eight hours to produce a positive electrode material for a lithium secondary battery.

Table 1 shows properties of the positive electrode active materials (a), (b), and (c), properties of hollow carbon fiber included in the carbon composite, and electrode resistance of the positive electrode materials for a lithium secondary battery in a room temperature. Here, the positive electrode materials (a) and (b) were manufactured through a baking for ten hours after diameters of the primary particles of source material powder are controlled during a pulverization time. The positive electrode active material (c) was baked for three hours. The pore diameter distribution in the positive electrode material was measured as follows. The positive electrode material for a lithium secondary battery was previously dried in vacuum at a temperature of 120° C. for two hours, and the powder was inserted into the measurement cell, so that the measurement was performed using a mercury penetration method at an initial pressure of 7 kPa. As a result, as the pore distribution of the positive electrode material for a lithium secondary battery, the accumulated amount of mercury penetrated into the pores having a diameter of 0.1 to 1 μm corresponding to the gap between primary particles of the positive electrode active material was 0.3 to 0.5 ml/g. In Table 1, the positive electrode material for a lithium secondary battery is called “a combined positive electrode material”.

TABLE 1

| | | | Accumulated | | | | | |
|---|---|---|---|---|---|---|---|---|
| | | Average | amount of | | | | | |
| | | primary | mercury | | | | | |
| | | particle | penetrated into | | | | | |
| | | diameter of | pores | | | | | |
| | | positive | (0.1-1 μm) | | Diameter | Average | Average | Electrode |
| | | electrode | of positive | | of hollow | length | amount of | resistance in |
| | | active | electrode active | | carbon | of hollow | absorbed liquid | room |
| Combined positive | Positive electrode | material | material | Hollow carbon | fiber | carbon fiber | into hollow | temperature |
| electrode material | active material | (μm) | (ml/g) | fiber | (nm) | (μm) | carbon fiber | (Ω) |
| Combined positive | Positive electrode | 2 | 0.3 | Carbon fiber (a) | 40 | 1 | 11 | 14 |
| electrode material (1) | active material (a) | | | | | | | |
| Combined positive | Positive electrode | 2 | 0.3 | Carbon fiber (b) | 40 | 2 | 10 | 13 |
| electrode material (2) | active material (a) | | | | | | | |
| Combined positive | Positive electrode | 2 | 0.3 | Carbon fiber (c) | 40 | 3 | 9 | 11 |
| electrode material (3) | active material (a) | | | | | | | |
| Combined positive | Positive electrode | 2 | 0.3 | Carbon fiber (d) | 40 | 5 | 6 | 11.5 |
| electrode material (4) | active material (a) | | | | | | | |
| Combined positive | Positive electrode | 2 | 0.3 | Carbon fiber (e) | 40 | 10 | 4 | 14.2 |
| electrode material (5) | active material (a) | | | | | | | |
| Combined positive | Positive electrode | 2 | 0.3 | Carbon fiber (f) | 10 | 3 | 5 | 13.5 |
| electrode material (6) | active material (a) | | | | | | | |
| Combined positive | Positive electrode | 2 | 0.3 | Carbon fiber (g) | 30 | 3 | 8 | 11 |
| electrode material (7) | active material (a) | | | | | | | |
| Combined positive | Positive electrode | 2 | 0.3 | Carbon fiber (h) | 50 | 3 | 10 | 11.1 |
| electrode material (8) | active material (a) | | | | | | | |
| Combined positive | Positive electrode | 2 | 0.3 | Carbon fiber (i) | 150 | 3 | 11 | 14.5 |
| electrode material (9) | active material (a) | | | | | | | |
| Combined positive | Positive electrode | 3 | 0.3 | Carbon fiber (a) | 40 | 1 | 11 | 15 |
| electrode material (10) | active material (b) | | | | | | | |
| Combined positive | Positive electrode | 3 | 0.3 | Carbon fiber (b) | 40 | 2 | 10 | 14.9 |
| electrode material (11) | active material (b) | | | | | | | |
| Combined positive | Positive electrode | 3 | 0.3 | Carbon fiber (c) | 40 | 3 | 9 | 14.8 |
| electrode material (12) | active material (b) | | | | | | | |
| Combined positive | Positive electrode | 3 | 0.3 | Carbon fiber (d) | 40 | 5 | 6 | 14.9 |
| electrode material (13) | active material (b) | | | | | | | |
| Combined positive | Positive electrode | 3 | 0.3 | Carbon fiber (e) | 40 | 10 | 4 | 15.2 |
| electrode material (14) | active material (b) | | | | | | | |
| Combined positive | Positive electrode | 3 | 0.3 | Carbon fiber (f) | 10 | 3 | 5 | 14.9 |
| electrode material (15) | active material (b) | | | | | | | |
| Combined positive | Positive electrode | 3 | 0.3 | Carbon fiber (g) | 30 | 3 | 8 | 15 |
| electrode material (16) | active material (b) | | | | | | | |
| Combined positive | Positive electrode | 3 | 0.3 | Carbon fiber (h) | 50 | 3 | 10 | 14.9 |
| electrode material (17) | active material (b) | | | | | | | |
| Combined positive | Positive electrode | 3 | 0.3 | Carbon fiber (i) | 150 | 3 | 11 | 15.5 |
| electrode material (18) | active material (b) | | | | | | | |
| Combined positive | Positive electrode | 1 | 0.5 | Carbon fiber (a) | 40 | 1 | 11 | 13.8 |
| electrode material (19) | active material (c) | | | | | | | |
| Combined positive | Positive electrode | 1 | 0.5 | Carbon fiber (b) | 40 | 2 | 10 | 13.7 |
| electrode material (20) | active material (c) | | | | | | | |
| Combined positive | Positive electrode | 1 | 0.5 | Carbon fiber (c) | 40 | 3 | 9 | 13.7 |
| electrode material (21) | active material (c) | | | | | | | |
| Combined positive | Positive electrode | 1 | 0.5 | Carbon fiber (d) | 40 | 5 | 6 | 13.5 |
| electrode material (22) | active material (c) | | | | | | | |
| Combined positive | Positive electrode | 1 | 0.5 | Carbon fiber (e) | 40 | 10 | 4 | 14.3 |
| electrode material (23) | active material (c) | | | | | | | |
| Combined positive | Positive electrode | 1 | 0.5 | Carbon fiber (f) | 10 | 3 | 5 | 13.7 |
| electrode material (24) | active material (c) | | | | | | | |
| Combined positive | Positive electrode | 1 | 0.5 | Carbon fiber (g) | 30 | 3 | 8 | 13.7 |
| electrode material (25) | active material (c) | | | | | | | |
| Combined positive | Positive electrode | 1 | 0.5 | Carbon fiber (h) | 50 | 3 | 10 | 13.7 |
| electrode material (26) | active material (c) | | | | | | | |
| Combined positive | Positive electrode | 1 | 0.5 | Carbon fiber (i) | 150 | 3 | 11 | 14.1 |
| electrode material (27) | active material (c) | | | | | | | |

In Table 1, the electric resistance (Ω) at a room temperate was measured using a positive electrode plate manufactured as follows. Firstly, as an aggregating agent, polyvinylidene-fluoride was dissolved with N-methyl-2-pyrrolidinone (hereinafter, referred to as NMP) of the solvent. The aggregating agent, the positive electrode material produced as described above, and a carbon based conductive material (plate shape graphite) were regularly mixed to produce positive electrode mixture slurry. In this case, the weight percentage of the positive electrode material for a lithium secondary battery, the carbon based conductive material, and the aggregating agent was set to 86:9.7:4.3. The slurry was regularly coated on the aluminum charge collector foil having a thickness of 20 μm, dried at a temperature of 100° C., and then, pressed using a press at a pressure of 1.5 ton/cm² to provide a conductive film having a thickness of about 40 μm.

This positive electrode plate was punched with a diameter of 15 mm, and a battery sample was manufactured using this positive electrode plate by forming a lithium electrode as an opposite electrode. A mixed solvent containing LiPF6 having a molecular ratio of 1.0, mixed with ethyl carbonate (hereinafter, referred to as EC), dimethyl carbonate (hereinafter, referred to as DMC), and diethyl carbonate (hereinafter, referred to as DEC) was used as electrolyte.

Internal resistance of a battery sample was measured as follows. A battery sample was charged with a constant current and a constant voltage up to a voltage of 4.2 V at a charge rate of 0.25 C, and then discharged at a discharge rate of 0.5 C, so that internal resistance was measure 10 seconds later after the discharge is initiated. The resultant measurement values are shown as “electrode resistance at a room temperature (Ω)” in Table 1.

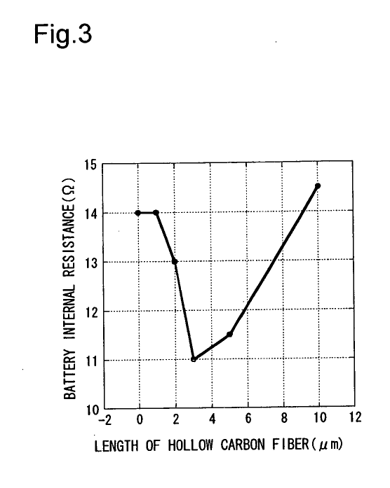

FIG. 3 is a graph illustrating a relationship between battery internal resistance at a room temperature (25° C.) and the length of the hollow carbon fiber. A mixed carbon material obtained by mixing hollow carbon fiber (c) having an average diameter of 40 nm and an average length of 3 μm and a hollow clumped carbon material having an average diameter of 100 nm (where, a weight percentage of the hollow carbon fiber is 75 wt. %) using a planetary ball mill for six hours was added to the positive electrode active material (a). In a battery sample in which the combined positive electrode material (3) is mixed using a ball mill, as shown in FIG. 3, the internal resistance of a battery at a room temperature was 11Ω, which has been significantly reduced. On the other hand, in another battery sample using the positive electrode active material and hollow carbon fiber having average lengths of 1 μm (No. 1) to 10 μm (No. 5) without adding the hollow clumped carbon material, the internal resistance of a battery was 14Ω or more, which shows that the internal resistance of all batteries formed of a combined positive electrode material manufactured by adding hollow carbon fiber is high. The internal resistance of the hollow carbon fiber having the average length of 2 to 8 μm was 13Ω or less, and the internal resistance of the hollow carbon fiber having the average length of 2.5 to 6 μm was 12Ω or less.

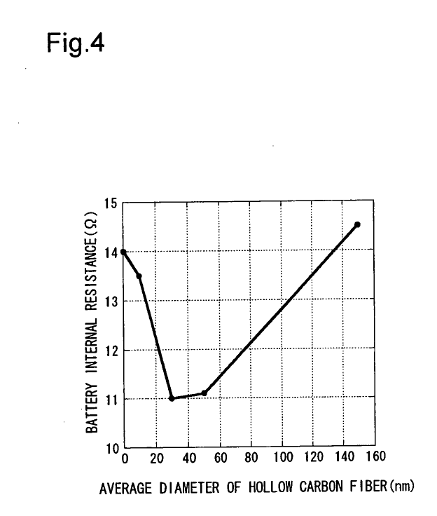

FIG. 4 is a graph illustrating a relationship between an average diameter of hollow carbon fiber and internal resistance of a battery. A mixed carbon material obtained by mixing hollow carbon fiber (g) having an average diameter of 30 nm and a hollow clumped carbon material having an average diameter of 100 nm (where, the weight percentage of the hollow carbon fiber is set to 75 wt. %) using a planetary ball mill for six hours was added to the positive electrode active material (a), and mixed using a ball mill to produce a combined positive electrode material (No. 7). A battery sample manufactured using the combined positive electrode material (No. 7) had internal resistance of 11Ω. Similarly, another battery manufactured using a combined positive electrode material (No. 8) containing hollow carbon fiber (h) having a diameter of 50 nm had internal resistance of 11.1Ω. When a combined positive electrode material is manufactured using the hollow carbon fiber having an average diameter of 15 to 110 nm, the internal resistance of a battery was 13Ω or less. Also, when a combined positive electrode material is manufactured by adding hollow carbon fiber having an average diameter of 20 to 85 nm, the internal resistance of a battery was 12.5Ω or less. In addition, in another battery sample manufactured using a combined positive electrode (No. 9) containing hollow carbon fiber (i) having a diameter of 150 nm, the internal resistance was 14.5Ω, which is nearly the same as that of the positive electrode active material that does not contain hollow carbon fiber.

In Table 1, based on a relationship between the amount of absorbed electrolyte of the positive electrode active material (a) containing the hollow carbon fiber and the internal resistance of a battery, if the amount of the absorbed electrolyte is 5 cc/g or more, and if the average particle diameter is 10 to 50 nm, the internal resistance of a battery is 13.5Ω or less.

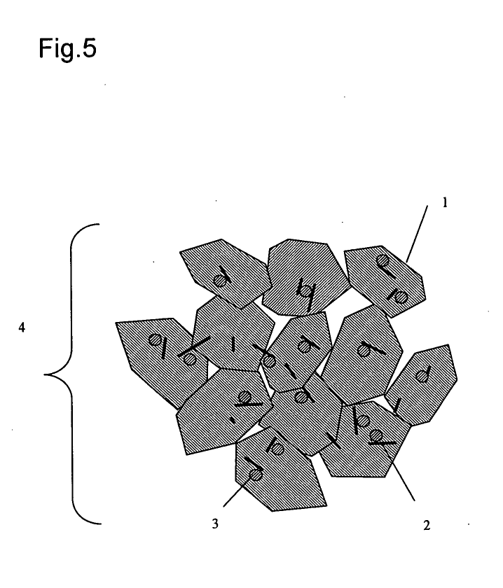

As shown in Table 1, when a positive electrode active material (b) having an average primary particle diameter of 3 μm is used (in case of No. 10 to 18), the internal resistance of a battery is nearly the same as that of a positive electrode active material that does not containing hollow carbon fiber. As shown in FIG. 5, the reason for this is considered that the amount of carbon fiber for interconnecting the primary particles constituting secondary particles of the positive electrode active material is small, and the conductive network cannot be formed in the secondary particles of the positive electrode active material as in Example 1.

On the other hand, another battery sample was manufactured using the positive electrode active material (a) and the hollow carbon fiber (c) through the same manufacturing process as those described above, and a relationship between the additive amounts of the hollow carbon fiber and the hollow clamped carbon material and the internal resistance of a battery has been reviewed. The result is shown in Table 2. In Table 2, the positive electrode material for a lithium secondary battery is referred to as “a combined positive electrode material”.

TABLE 2

| | | | | | Average particle | |
|---|---|---|---|---|---|---|
| | | | | | diameter | |
| | Average primary | Accumulated amount of | | | of hollow | |
| | particle diameter of | mercury penetrated into | | | clumped | |
| | positive electrode | pores (0.003-0.1 μm) of | Additive amount | Additive amount of | shape | Electrode |
| Positive electrode | active material | combined positive | of carbon | hollow carbon | carbon | resistance in room |
| material | (μm) | electrode material (ml/g) | mixture (wt. %) | fiber (c) (wt. %) | material (nm) | temperature (Ω) |
| Combined positive | 2 | 0 | 0.0 | — | — | 15.0 |
| electrode material (28) | | | | | | |
| Combined positive | 2 | 0.01 | 3.0 | 75.0 | 100.0 | 13.8 |
| electrode material (29) | | | | | | |
| Combined positive | 2 | 0.03 | 6.1 | 75.0 | 100.0 | 11.0 |
| electrode material (30) | | | | | | |
| Combined positive | 2 | 0.03 | 7.0 | 75.0 | 100.0 | 11.3 |
| electrode material (31) | | | | | | |
| Combined positive | 2 | 0.04 | 10.0 | 75.0 | 100.0 | 15.0 |
| electrode material (32) | | | | | | |
| Combined positive | 2 | 0.01 | 3.0 | 90.0 | 100.0 | 14.5 |
| electrode material (33) | | | | | | |
| Combined positive | 2 | 0.03 | 6.1 | 90.0 | 100.0 | 11.6 |
| electrode material (34) | | | | | | |
| Combined positive | 2 | 0.03 | 7.0 | 90.0 | 100.0 | 11.9 |
| electrode material (35) | | | | | | |
| Combined positive | 2 | 0.04 | 10.0 | 90.0 | 100.0 | 15.8 |
| electrode material (36) | | | | | | |
| Combined positive | 2 | 0.01 | 3.0 | 100.0 | 100.0 | 15.2 |
| electrode material (37) | | | | | | |
| Combined positive | 2 | 0.02 | 6.1 | 100.0 | 100.0 | 12.1 |
| electrode material (38) | | | | | | |
| Combined positive | 2 | 0.02 | 7.0 | 100.0 | 100.0 | 12.4 |
| electrode material (39) | | | | | | |
| Combined positive | 2 | 0.03 | 10.0 | 100.0 | 100.0 | 16.5 |
| electrode material (40) | | | | | | |
| Combined positive | 2 | 0.01 | 3.0 | 50.0 | 100.0 | 14.6 |
| electrode material (41) | | | | | | |
| Combined positive | 2 | 0.04 | 6.1 | 50.0 | 100.0 | 11.7 |
| electrode material (42) | | | | | | |
| Combined positive | 2 | 0.05 | 7.0 | 50.0 | 100.0 | 12.0 |
| electrode material (43) | | | | | | |
| Combined positive | 2 | 0.06 | 10.0 | 50.0 | 100.0 | 15.9 |
| electrode material (44) | | | | | | |
| Combined positive | 2 | 0.03 | 3.0 | 40.0 | 100.0 | 17.9 |
| electrode material (45) | | | | | | |
| Combined positive | 2 | 0.04 | 6.1 | 40.0 | 100.0 | 14.3 |
| electrode material (46) | | | | | | |
| Combined positive | 2 | 0.05 | 7.0 | 40.0 | 100.0 | 14.7 |
| electrode material (47) | | | | | | |
| Combined positive | 2 | 0.06 | 10.0 | 40.0 | 100.0 | 19.5 |
| electrode material (48) | | | | | | |
| Combined positive | 2 | 0.01 | 3.0 | 75.0 | 110.0 | 18.0 |
| electrode material (49) | | | | | | |
| Combined positive | 2 | 0.03 | 6.1 | 75.0 | 110.0 | 17.0 |
| electrode material (50) | | | | | | |
| Combined positive | 2 | 0.03 | 7.0 | 75.0 | 110.0 | 16.0 |
| electrode material (51) | | | | | | |
| Combined positive | 2 | 0.04 | 10.0 | 75.0 | 110.0 | 19.0 |
| electrode material (52) | | | | | | |

As recognized from Table 2, the internal resistance of a battery is reduced by adding the hollow carbon fiber and the hollow clamped shape carbon material to the positive electrode active material. In addition, in the carbon composite, when the weight ratio between the hollow carbon fiber and the hollow clamped shape carbon material is set to 3:1, and the additive amount to the carbon mixture containing the hollow carbon fiber (c) is 6.1 wt. % (No. 30) and 7.0 wt. % (No. 31), respectively, the internal resistance of a battery was in the vicinity of 11.3Ω, which was significantly reduced. On the contrary, if the hollow carbon fiber and the hollow clumped carbon material are not provided as in No. 28, or if the weight percentage is 10 wt. % as in No. 32, the internal resistance of a battery increases. When the additive amount of the carbon mixture (e.g., the combined positive electrode materials No. 29 to 31) is 3 to 7 wt. %, the internal resistance of a battery can be reduced to 13.8Ω or less. In addition, in the combined positive electrode materials of No. 29 to 31, the accumulated amount of mercury penetrated into the minute pores having a diameter of 0.003 to 0.1 μm of the combined positive electrode material using a mercury penetration method was 0.02 ml/g or more. This shows that the electrode resistance can be reduced using a combined positive electrode material having minute pores.

As recognized from Table 2, when the weight ratio between the hollow carbon fiber and the hollow clumped carbon material in the carbon composite is set to 1:1 as in No. 41 to 44, and when the additive amount of the carbon mixture is 6.1 wt. % as in No. 42 and 7.0 wt. % as in No. 43, the internal resistance of a battery was 11.7Ω and 12.0Ω, respectively, which shows that internal resistance of a battery is decreased. Also, as recognized from Table 2, in the carbon composite, when the weight ratio between the hollow carbon fiber and the hollow clamped shape carbon material was set to 4:6 as in No. 45 to 48, the internal resistance of a battery was 14.3 to 19.5Ω, which is nearly the same as that of the positive electrode active material that does not contain the hollow carbon fiber.

In addition, as recognized from Table 2, when the weight ratio between the hollow carbon fiber (c) and the hollow clumped carbon material having an average diameter of 110 nm is set to 3:1 as in No. 49 to 52, the internal resistance of a battery was 16.0 to 19.0Ω, which is nearly the same as that of the positive electrode active material that does not contain the hollow carbon fiber.

As a result of the measurement for the amount of retained electrolyte of the hollow clumped carbon material having an average diameter of 100 nm that has been used in the above cases, the amount of retained electrolyte was 15 cc/g, which is an excellent liquid-retaining property for electrolyte.

### Comparative Example 1

As Comparative Example 1, a positive electrode material for a lithium secondary battery was manufactured by simultaneously mixing the positive electrode active material (a) or (c), the hollow carbon fiber (c), and the hollow clamped shape carbon material having an average diameter of 100 nm. In other words, in Comparative Example 1, the carbon composite is not prepared, but the positive electrode active material, the carbon fiber, and the clamped shape carbon material are mixed.

Similarly to Example 1, a battery sample was manufactured in Comparative Example 1, and the electrode resistance was measured at a room temperature. The result is shown in Table 3.

TABLE 3

| | | Average primary | | | | Electrode |
|---|---|---|---|---|---|---|
| | | particle diameter | | Diameter | Average diameter | resistance |
| | | of positive | | of hollow | of hollow carbon | in room |
| Combined positive | Positive electrode active | electrode active | | carbon | fiber | temperature |
| electrode material | material | material (μm) | Hollow carbon fiber | fiber (nm) | (μm) | (Ω) |
| Combined positive | Positive electrode active | 2 | Carbon fiber (c) | 40 | 3 | 14.9 |
| electrode material A (1) | material (a) | | | | | |
| Combined positive | Positive electrode active | 1 | Carbon fiber (c) | 40 | 3 | 13.7 |
| electrode material A (2) | material (b) | | | | | |

When the result of Table 3 is compared with the composite electrode materials of No. 3 and No. 21 in Table 1, it is recognized that the positive electrode material produced in Comparative Example has relatively high electrode resistance at a room temperature. As a result of comparison, it is obvious that a conductive network is not provided between primary particles of the positive electrode material in the positive electrode plate manufactured by using the positive electrode material produced in Comparative Example 1.

### Example 2

In Example 2, a compact cylindrical battery was manufactured through the following procedures in order to evaluate the life cycle characteristic of a combined positive electrode material. The positive electrode plate manufactured using a combined positive electrode material of No. 3 according to Example 1 was cut away to have a width of 5.4 cm and a length of 50 cm, and a lead made of an aluminum foil is welded to it to extract currents, so that a positive electrode plate was manufactured.

Subsequently, a negative electrode plate was manufactured to provide a compact cylindrical battery (as shown in FIG. 2) by assembling the positive and negative electrode plates. Pseudo isotropic carbon (hereinafter, referred to as PIC) corresponding to amorphous carbon of a negative electrode material was dissolved into an aggregating agent, NMP, to provide negative electrode mixture slurry. In this case, a dried weight ratio between the PIC and the aggregating agent was set to 92:8. This slurry was regularly coated on the pressed copper film having a thickness of 10 μm. Then, the film was pressed by a roll press machine and cut away to have a width of 5.6 cm and a length of 54 cm, and a lead formed of a copper foil is welded to it, so that a negative electrode plate was manufactured.

A cylindrical battery (as shown in FIG. 2) was manufactured according to the following procedures. Firstly, the positive and negative electrode plates and a separator interposed therebetween to prevent a direct contact of them are wound, so that an electrode assembly was manufactured. In this case, the positive and negative electrode leads are disposed in opposite sides of the electrode assembly. In addition, the positive and negative electrode plates are disposed such that the positive electrode slurry coat is not protruded from the negative electrode slurry coat. The separator used in this case is a micro-porous polypropylene film having a thickness of 25 μm and a width of 5.8 cm. Subsequently, the electrode assembly is inserted into the battery can formed of an SUS steel, the negative electrode lead is welded to the bottom face of the can, and the positive electrode lead is welded to the seal cover also functioning as a positive electrode current switch. Nonaqueous electrolyte is inserted into the battery can having the electrode assembly, where the electrolyte is obtained by dissolving LiPF₆ having a molarity of 1.0 molecule/liter into a mixed solvent of EC, DMC, and DEC having a volume ratio of 1:1:1. Then, packings are attached to upper and lower ends, and the seal cover is corked on top of the battery can to seal it, so that a cylindrical battery having a diameter of 18 mm and a length of 65 mm was obtained. In this case, a safety valve is provided in the seal cover to be opened when the inner pressure of the battery is abnormally increased to reduce the inner pressure of the battery. An insulating material is provided between the seal cover and the battery can.

The charge/discharge cycle characteristic of the manufactured battery was measured by setting a charge termination voltage to 4.2 V, a discharge termination voltage to 3.0 V, and a discharge rate to 0.5 C. As a result of a life span test for 200 cycles, the capacity retention ratio was advantageously 88.5%.

Furthermore, a large-size cylindrical battery having a diameter of 40 mm and a length of 108 mm was manufactured similarly to a method of manufacturing a compact cylindrical battery as described above. The internal resistance of this battery was measured according to the following procedures. The battery was charged with a constant voltage and a constant current up to 4.2 V with a charge rate of 0.25 C, and then discharge with a discharge rate of 0.5 C, so that the internal resistance of the battery was measured. When the positive electrode material according to the present invention is used, the output energy density was 2800 to 4000 W/Kg if the depth of discharge was set to 50%.

### Example 3

In Example 3, manganese dioxide, cobalt oxide, and nickel oxide, and lithium carbonate were used as a source material. Materials were weighed such that the atomic ratio of Ni:Mn:Co is set to 0.6:0.2:0.2, and the atomic ratio of Li:(NiMnCo) is set to 1.03:1, and then, pure water was added. Using a pot made of resin and a ball mill made of a zirconia ball, the materials are pulverized and mixed in a wet environment so that the particle diameter is reduced to a submicron scale. A polyvinyl alcohol (PVA) liquid is added to a mixture with a solid content ratio of 0.2 wt. %, mixed again for an hour, and granulated and dried using a spray drier, so that particles having a diameter of 5 to 100 μm were produced. Subsequently, these particles were baked at a temperature of 1000° C. for twenty to fifty hours so as to have a layered crystal structure, and then decomposed to provide a positive electrode active material. Bulky particles having a diameter of 50 μm or more are removed from the positive electrode active material through a classification process, and then the resulting material was applied to an electrode manufacturing. In this case, the primary particle diameter of the source material powder was controlled by the pulverization time, so that a sample having the same particle structure as that of the positive electrode active material (a) of Example 1 was manufactured.

Similarly to Example 1, the positive electrode material for a lithium secondary battery was manufactured by mixing carbon fiber, and the internal resistance of a battery sample was measured. As a result, it was possible to obtain effect of reducing the internal resistance of a battery using a combined positive electrode material similarly to Example 1.

Then, a compact cylindrical battery was manufactured similarly to Example 2. The charge/discharge cycle characteristic of the manufactured battery was measured by setting a charge termination voltage to 4.2 V, a discharge termination voltage to 3.0 V, and a discharge rate to 0.5 C. As a result of a life span test for 200 cycles, the capacity retention ratio was advantageously 79.1%. This shows that the life span is relatively reduced in comparison with when a positive electrode active material according to Example 2 was used.

1-2. (canceled)

3. A positive electrode material for a lithium secondary battery comprising: a secondary particle comprising a plurality of primary particles of a positive electrode active material containing lithium oxide; and a carbon composite in which a clumped carbon material is dispersed and in contact with hollow carbon fibers, wherein the hollow carbon fibers have openings on their side walls, and wherein the positive electrode active material is combined with the carbon composite such that the carbon composite is dispersed into a surface of the primary particles of the positive electrode active material.

4. The positive electrode material for a lithium secondary battery according to claim 3, wherein the opening has a diameter of 10 to 50 nm.

5. The positive electrode material for a lithium secondary battery according to claim 3, wherein the carbon fibers have an average length of 1 to 8 μm, and the clumped carbon material has an average particle diameter of 100 nm or less.

6. The lithium secondary battery according to claim 11, wherein part of the electrolyte is retained in the carbon composite, and an amount of electrolyte retained in the carbon composite is 5 cc/g or more.

7. The positive electrode material for a lithium secondary battery according to claim 3, wherein the carbon fiber in the carbon composite has a weight percentage of 50 to 90 wt. %.

8. The positive electrode material for a lithium secondary battery according to claim 3, wherein the positive electrode active material contains, as a main component, layered composite oxide having a chemical formulation of LiₐMO₂, where 0<a≦1.2, and M is at least one material selected from a group consisting of Co, Ni, and Mn.

9. The positive electrode material for a lithium secondary battery according to claim 8, wherein the layered composite oxide has a chemical formulation of LiₐMnₓNi_{y}Co_{z}O₂, where 0<a≦1.2, 0.1≦x≦0.9, 0.1≦y≦0.44, 0.1≦z≦0.6, and x+y+z=1.

10. A positive electrode plate for a lithium secondary battery, wherein the positive electrode plate is formed by coating the positive electrode material for a lithium secondary battery according to claim 3 on a metal foil.

11. A lithium secondary battery comprising: the positive electrode plate for a lithium secondary battery according to claim 10; a negative electrode plate; and electrolyte.

12. The lithium secondary battery according to claim 11, wherein the lithium secondary battery has an output energy density of 2800 to 4000 W/Kg when a depth of discharge is set to 50% at a temperature of 25° C.

13-15. (canceled)

16. A positive electrode material for a lithium secondary battery, the positive electrode material being manufactured by a method wherein a carbon fiber is mixed with a shearing force being applied, and then, a clumped carbon material is added to be further mixed to form a carbon composite containing the carbon fiber and the clumped carbon material, and then a positive electrode active material is combined with the carbon composite containing the carbon fiber and the clumped carbon material.

17. A positive electrode plate for a lithium secondary battery, wherein the positive electrode plate is formed by coating the positive electrode material for a lithium secondary battery according to claim 16 on a metal foil.

18. A lithium secondary battery comprising: the positive electrode plate for a lithium secondary battery according to claim 17; a negative electrode plate; and electrolyte.

19. The positive electrode material for a lithium secondary battery according to claim 3, wherein the primary particles of the positive electrode active material have an average particle diameter of 0.1 to 3 μm.

20. The positive electrode material for a lithium secondary battery according to claim 19, wherein the primary particles of the positive electrode active material have a specific surface area of 1 m²/g or more.

21. The positive electrode material for a lithium secondary battery according to claim 3, wherein the secondary particle has a spherical shape.

22. The lithium secondary battery according to claim 11, wherein part of the electrolyte is retained in the carbon composite, and an amount of electrolyte retained in the carbon composite is 3 cc/g or more.

23. The positive electrode material for a lithium secondary battery according to claim 3, wherein minute pores between the primary particles have a diameter of 0.003 to 0.1 μm.

24. The positive electrode material for a lithium secondary battery according to claim 3, wherein the material has minute pores having a diameter of 0.003 to 0.1 μm such that accumulated amount of mercury penetrated into the minute pores is 0.02 ml/g or more using a mercury penetration method.
